(19) United States
(12) Patent Application Publication
(10) Pub. No.: US 2026/0042170 A1
(43) Pub. Date: Feb. 12, 2026

(54) DYNAMIC CONTROL OF OPERATIONAL PARAMETERS IN LASER-BASED SHEET METAL CUTTING

(71) Applicant: INTERNATIONAL BUSINESS MACHINES CORPORATION, ARMONK, NY (US)

(72) Inventors: Sarbajit Kumar Rakshit, Kolkata (IN); Sudheesh S. Kairali, Kozhikode (IN); Binoy Thomas, Kozhikode (IN)

(21) Appl. No.: 18/800,243

(22) Filed: Aug. 12, 2024

(51) Int. Cl. B23K 26/16; B23K 26/03; B23K 26/38

(52) U.S. Cl. CPC B23K 26/16; B23K 26/032; B23K 26/38

(57) ABSTRACT

An embodiment for dynamic control of operational parameters in laser-based sheet metal cutting is provided. The embodiment may include receiving real-time and historical data from one or more sources. The embodiment may also include computing one or more operational parameters during a cutting of a piece of sheet metal. The embodiment may further include identifying a cut profile and one or more specifications of the piece of sheet metal. The embodiment may also include based on determining a problem condition occurs in at least one region of one or more regions of the piece of sheet metal, correlating the one or more operational parameters with the at least one region where the problem condition occurred. The embodiment may further include identifying at least one operational parameter that resulted in the problem condition. The embodiment may also include adapting the at least one operational parameter.

### BACKGROUND

The present invention relates generally to the field of computing, and more particularly to a system for dynamic control of operational parameters in laser-based sheet metal cutting.

Laser beam-based sheet metal cutting is a precision manufacturing process that employs a high-intensity laser beam to accurately and efficiently cut through various types of sheet metal. The process involves focusing the laser beam onto a surface of the material, which may melt and vaporize the material, creating a narrow cut with minimal heat-affected zones. The intensity of the laser beam and focused spot size are carefully controlled to ensure clean and precise cuts without the need for physical contact or mechanical force.

### SUMMARY

According to one embodiment, a method, computer system, and computer program product for dynamic control of operational parameters in laser-based sheet metal cutting is provided. The method, computer system, and computer program product may include receiving real-time and historical data from one or more sources in a sheet metal cutting environment. The method, computer system, and computer program product may also include computing one or more operational parameters during a cutting of a piece of sheet metal based on the real-time data. The method, computer system, and computer program product may further include identifying a cut profile and one or more specifications of the piece of sheet metal based on the real-time data. The method, computer system, and computer program product may also include based on determining a problem condition occurs in at least one region of one or more regions of the piece of sheet metal, correlating the one or more operational parameters with the at least one region where the problem condition occurred. The method, computer system, and computer program product may further include identifying at least one operational parameter that resulted in the problem condition based on the correlation. The method, computer system, and computer program product may also include adapting the at least one operational parameter such that the problem condition is eliminated based on the historical data.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for dynamic control of operational parameters in laser-based sheet metal cutting in a dynamic operational parameter control process according to at least one embodiment.

FIG. 3 is an exemplary diagram depicting a laser-based cutting of a sheet metal according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for dynamic control of operational parameters in laser-based sheet metal cutting. The following described exemplary embodiments provide a system, method, and program product to, among other things, determine whether a problem condition occurs at one or more regions of a piece of sheet metal and, accordingly, adapt at least one operational parameter such that the problem condition is eliminated. Therefore, the present embodiment has the capacity to improve industrial technology by managing various factors to prevent boundary layer separation and achieve optimal cut quality.

As previously described, laser beam-based sheet metal cutting is a precision manufacturing process that employs a high-intensity laser beam to accurately and efficiently cut through various types of sheet metal. The process involves focusing the laser beam onto a surface of the material, which may melt and vaporize the material, creating a narrow cut with minimal heat-affected zones. The intensity of the laser beam and focused spot size are carefully controlled to ensure clean and precise cuts without the need for physical contact or mechanical force. During the sheet metal cutting process, boundary layer separation can occur for internal flows. This problem is typically addressed with an aero/hydrodynamic regulation of the primary flow of Newtonian fluid in a radial turbomachine. However, the regulation is more related to aerodynamics and fluid dynamics in the context of turbomachinery rather than metal cutting processes.

It may therefore be imperative to have a system in place to properly tune operational parameters to maintain a steady and effective gas flow. Thus, embodiments of the present invention may provide advantages including, but not limited to, managing various factors to prevent boundary layer separation and achieve optimal cut quality, maintaining a steady and effective gas flow, and preventing defects from forming in the resulting sheet metal. The present invention does not require that all advantages need to be incorporated into every embodiment of the invention.

According to at least one embodiment, when cutting a piece of sheet metal, real-time and historical data from one or more sources in a sheet metal cutting environment may be received in order to compute one or more operational parameters during the cutting of the piece of sheet metal based on the real-time data. Upon computing the one or more operational parameters, a cut profile and one or more specifications of the piece of sheet metal may be identified so that it may be determined whether a problem condition occurs in one or more regions of the piece of sheet metal based on the cut profile and the one or more specifications. Then, based on determining the problem condition occurs in at least one region of the one or more regions, the one or more operational parameters may be correlated with the at least one region where the problem condition occurred such that at least one operational parameter that resulted in the problem condition may be identified based on the correlation. Upon identifying the at least one operational parameter that resulted in the problem condition, the at least one operational parameter may be adapted such that the problem condition is eliminated based on the historical data.

According to at least one embodiment, the adapted operational parameter may be a flow rate of a gas. According to at least one other embodiment, the adapted operational parameter may be a pressure of the gas. According to at least one further embodiment, the adapted operational parameter may be an angle of a nozzle applying the gas.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to determine whether a problem condition occurs at one or more regions of a piece of sheet metal and, accordingly, adapt at least one operational parameter such that the problem condition is eliminated.

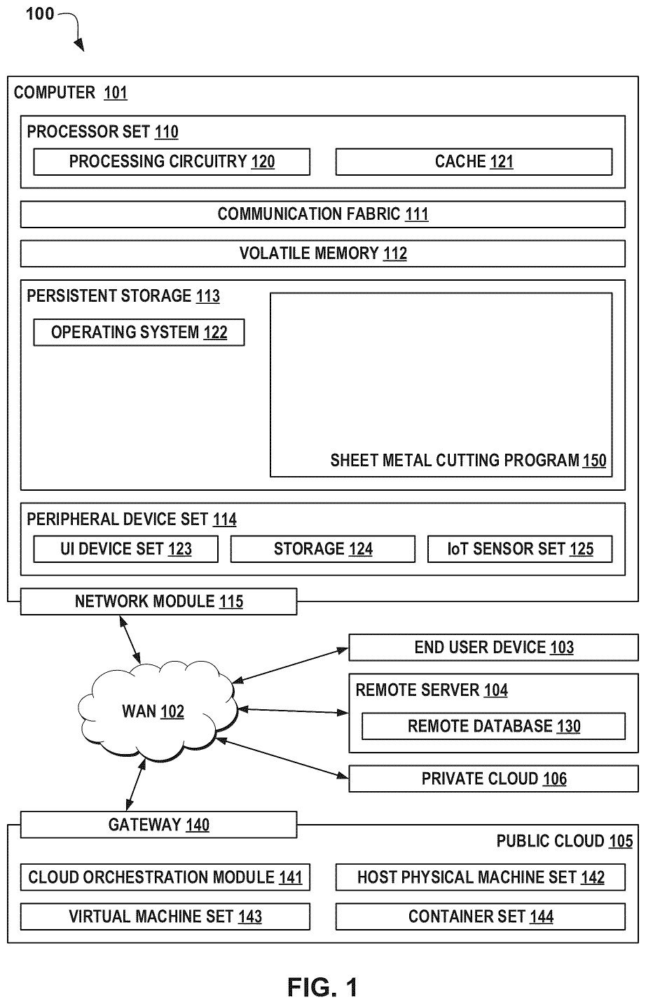

Referring to FIG. 1, an exemplary computing environment 100 is depicted, according to at least one embodiment. Computing environment 100 contains an example of an environment for the execution of at least some of the computer code involved in performing the inventive methods, such as a sheet metal cutting program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip. ” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include a laser cutting device, a backpressure module, a Schlieren Imaging System, and/or flow rate and pressure sensors.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

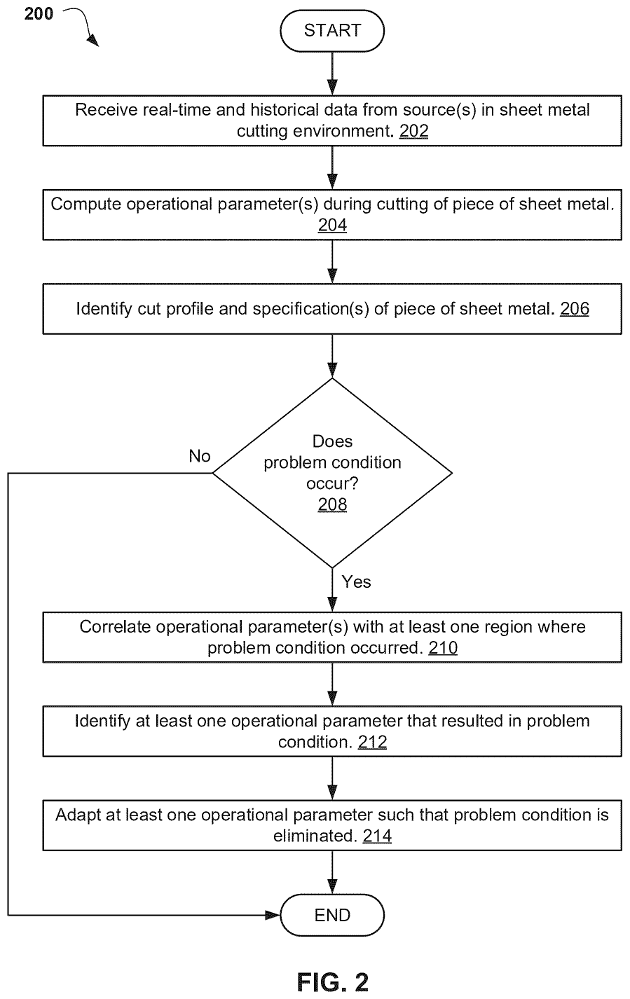

According to the present embodiment, the sheet metal cutting program 150 may be a program capable of receiving real-time and historical data from one or more sources in a sheet metal cutting environment, determining whether a problem condition occurs at one or more regions of a piece of sheet metal, adapting at least one operational parameter such that the problem condition is eliminated, managing various factors to prevent boundary layer separation and achieve optimal cut quality, maintaining a steady and effective gas flow, and preventing defects from forming in the resulting sheet metal. Furthermore, notwithstanding depiction in computer 101, the sheet metal cutting program 150 may be stored in and/or executed by, individually or in any combination, end user device 103, remote server 104, public cloud 105, and private cloud 106. The sheet metal cutting method is explained in further detail below with respect to FIG. 2. It may be appreciated that the examples described below are not intended to be limiting, and that in embodiments of the present invention the parameters used in the examples may be different.

Referring now to FIG. 2, an operational flowchart for dynamic control of operational parameters in laser-based sheet metal cutting in a dynamic operational parameter control process 200 is depicted according to at least one embodiment. At 202, the sheet metal cutting program 150 receives the real-time and the historical data from the one or more sources in the sheet metal cutting environment. The real-time data may include, but is not limited to, pressure of a gas, flow rate of the gas, cutting speed, an angle of a nozzle applying the gas, and/or backflow of the gas. For example, the pressure of the gas may be 20 pounds per square inch (PSI). The one or more sources may include, but are not limited to, a laser cutting device, a backpressure module, a Schlieren Imaging System, and/or flow rate and pressure sensors.

The historical data may include, but is not limited to, a historical dataset of schlieren images, historical operational parameters associated with the historical dataset of schlieren images, historical cut profiles, and/or historical specifications of different types of sheet metals. The historical data may be input into and retrieved from a knowledge corpus, such as remote database 130. In this manner, the sheet metal cutting program 150 may learn from the historical data.

Then, at 204, the sheet metal cutting program 150 computes the one or more operational parameters during the cutting of the piece of sheet metal. The one or more operational parameters are computed based on the real-time data. As described above with respect to step 202, examples of the operational parameter may include, but are not limited to, pressure of the gas, flow rate of the gas, cutting speed of the piece of sheet metal, the angle of a nozzle applying the gas, backflow of the gas, and/or type of gas (e.g., oxygen or nitrogen).

According to at least one embodiment, the flow rate and pressure sensors may be embedded in the laser cutting device to measure the flow rate of the gas and the pressure of the gas. For example, during the current laser-based sheet metal cutting operation, the measured flow rate of the gas may be 10 meters per second (m/s) and the measured pressure of the gas may be 20 PSI. The laser cutting device may determine the cutting speed of the piece of sheet metal to be 25 meters per minute (m/min).

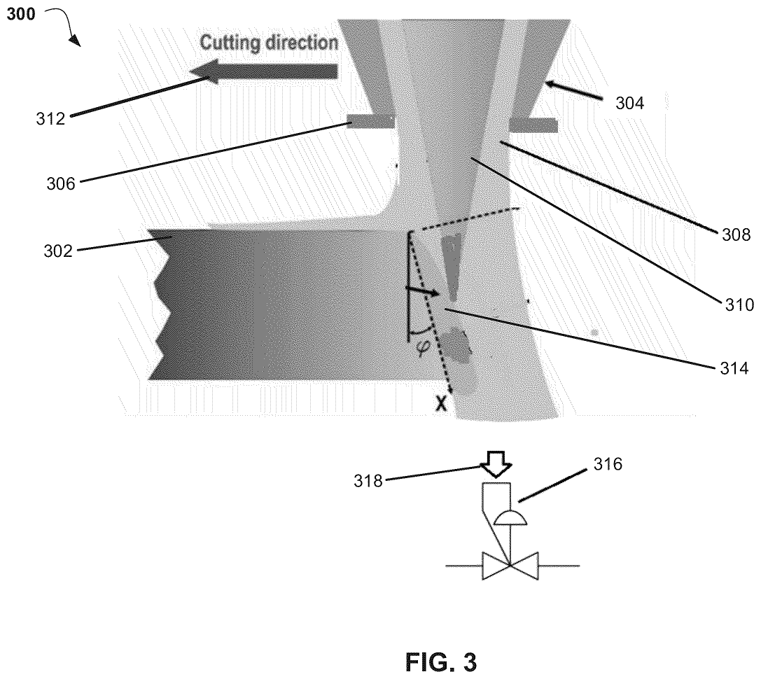

According to at least one other embodiment, the schlieren imaging system may be integrated with the laser cutting device. Specifically, the schlieren imaging system may be integrated with a control and monitoring system of the laser cutting device. In this manner, the schlieren images may be captured at the same time as the laser-based sheet metal cutting operation. The schlieren imaging system may include lenses attached to a bottom portion of the nozzle applying the gas, as illustrated in FIG. 3. It may be appreciated that in embodiments of the present invention, the nozzle that applies the gas may also apply the laser beam that cuts the piece of sheet metal, as illustrated in FIG. 3. The schlieren imaging system may capture one or more schlieren images during the current laser-based sheet metal cutting operation. From these schlieren images, the remaining operational parameters may be computed. For example, the measured backflow of the gas may be 5 m/s, the measured angle of the nozzle applying the gas may be 45° with respect to a platform on which the piece of sheet metal rests, and the type of gas may be detected as oxygen.

Next, at 206, the sheet metal cutting program 150 identifies the cut profile and the one or more specifications of the piece of sheet metal. The cut profile and the one or more specifications are identified based on the real-time data. The lenses of the schlieren imaging system may capture the cut profile and the one or more specifications of the piece of sheet metal.

The one or more specifications may include, but are not limited to, a thickness of the piece of sheet metal, including whether the piece of sheet metal has a uniform or varied thickness, dimensions of the piece of sheet metal, and/or a thermal conductivity of the piece of sheet metal.

For example, the sheet metal cutting program 150 may identify from the schlieren images that the piece of sheet metal is a rectangular object having a uniform thickness of 3 inches. The rectangular object may also be determined to be a good conductor of heat. In another example, the sheet metal cutting program 150 may identify from the schlieren images that the piece of sheet metal is a circular object having a varied thickness of 3 inches at the center and 1.5 inches at the edges. The circular object may also be determined to be a poor conductor of heat.

The cut profile may include, but are not limited to, curvatures, angles, and/or straight lines in the piece of sheet metal depending on an intended use of the piece of sheet metal. For example, where the intended use of the piece of sheet metal is as a cookie sheet, various curves and angles may be cut into the piece of sheet metal to mold cookies into different shapes. In another example, where the intended use of the piece of sheet metal is as a boat dock, straight lines may be cut across the piece of sheet metal to divide the boat dock into several sections.

Then, at 208, the sheet metal cutting program 150 determines whether the problem condition occurs in the one or more regions of the piece of sheet metal. The determination is made based on the cut profile and the one or more specifications. The problem condition may be a boundary layer separation at the one or more regions of the piece of sheet metal. A boundary layer separation may occur when there is an abrupt change in a magnitude or direction of a gas that is too great for the gas to keep to a solid surface. The boundary layer separation may include a backflow of the gas. For example, the flow rate and pressure of the gas may cause the gas to deflect off of the various curves and angles created during the laser-based sheet metal cutting operation, resulting in the backflow.

According to at least one embodiment, determining that the problem condition occurs in the one or more regions may include detecting the boundary layer separation in the one or more regions in real-time based on the one or more captured schlieren images during the cutting of the piece of sheet metal. The one or more captured schlieren images may include images of the gas separating from the surface of the piece of sheet metal (i.e., the boundary layer separation). By performing boundary layer separation analysis through schlieren image analysis, the sheet metal cutting program 150 may recognize the characteristics of the boundary layer separation in the one or more schlieren images. The characteristics of the boundary layer separation may include the severity of the boundary layer separation. For example, the boundary layer separation may occur at the one or more regions in the piece of sheet metal where the curvatures and angles exist. In this embodiment, the one or more specifications may confirm the boundary layer separation illustrated in the one or more schlieren images. For example, since the thickness of the piece of sheet metal is directly proportional to the likelihood of boundary layer separation, a thicker piece of sheet metal is more likely to result in a boundary layer separation.

According to at least one other embodiment, determining that the problem condition occurs in the one or more regions may also include predicting the boundary layer separation in the one or more regions based on the historical data. The historical dataset of schlieren images, historical operational parameters associated with the historical dataset of schlieren images, historical cut profiles, and/or historical specifications of different types of sheet metals received above with respect to step 202 may be used to predict the boundary layer separation proactively. The historical schlieren images and associated data may indicate the scenarios under which boundary layer separation occurred in the past under different operational parameters as well as different cut profiles, specifications, and/or materials.

For example, the historical schlieren images may indicate that boundary layer separation occurred when the material of the piece of sheet metal was aluminum but did not occur when the piece of sheet metal was titanium. In another example, the historical schlieren images may indicate that the boundary layer separation occurred when the aluminum was 5 inches thick but did not occur when the aluminum was 2 inches thick. In a further example, the historical schlieren images may indicate that boundary layer separation occurred when the aluminum included a curved and angled cut profile but did not occur when the aluminum included a straight cut profile.

The historical schlieren dataset may then be compared with the current operational parameters as well as the current specifications and cut profile to predict whether boundary layer separation will occur during the current laser-based sheet metal cutting operation. For example, when boundary layer separation occurred when the material of the piece of sheet metal was aluminum at 5 inches thick, the aluminum had a curved and angled cut profile, the gas flow rate was 10 m/s, and the measured pressure of the gas was 20 PSI, and during the current laser-based sheet metal cutting operation the values for the operational parameters, cut profile, and specifications are the same, the sheet metal cutting program 150 may predict the boundary layer separation will occur. Continuing the example, when during the current laser-based sheet metal cutting operation the values for the operational parameters, cut profile, and specifications are not the same, the sheet metal cutting program 150 may predict the boundary layer separation will not occur.

According to at least one further embodiment, a prediction module may be trained on the historical operational parameters, historical cut profiles, and/or historical specifications. The trained prediction module may be fed with the current operational parameters, specifications, and/or cut profile to predict a likelihood of boundary layer separation during the current laser-based sheet metal cutting operation. For example, the trained prediction module may predict the likelihood of boundary layer separation to be 75%. A threshold probability value may be set above which the trained prediction module considers the risk of boundary layer separation to be significant. For example, the threshold may be 70%. When the predicted probability is greater than the threshold, the sheet metal cutting program 150 may generate a warning notification indicating the high probability of boundary layer separation. For example, where the likelihood of boundary layer separation is 75%, and the threshold is 70%, the warning notification may be generated.

Based on determining the problem condition occurs in at least one region of the one or more regions of the piece of sheet metal (step 208, “Yes” branch), the dynamic operational parameter control process 200 proceeds to step 210 to correlate the one or more operational parameters with the at least one region where the problem condition occurred. Based on determining the problem condition does not occur in the at least one region of the one or more regions of the piece of scrap metal (step 208, “No” branch), the dynamic operational parameter control process 200 ends.

Next, at 210, the sheet metal cutting program 150 correlates the one or more operational parameters with the at least one region where the problem condition occurred. As described above with respect to step 208, the historical operational parameters may be associated with the historical dataset of schlieren images. Similar to how the historical operational parameters are associated with the historical dataset of schlieren images, the one or more operational parameters may also be correlated with the at least one region where the problem condition occurred. During the current laser-based sheet metal cutting operation, the lenses of the schlieren imaging system may track a path of the laser beam and a position of the sheet metal, which may assist in mapping the at least one operational parameter to specific regions of the cut. The correlation may be made between the one or more operational parameters and the at least one region where the problem condition occurred in the schlieren images. In this manner, the schlieren images may be associated with the one or more operational parameters.

For example, the boundary layer separation may occur at the one or more regions in the piece of sheet metal where the curvatures and angles exist. The sheet metal cutting program 150 may identify the one or more operational parameters that are present at those one or more regions at the time the boundary layer separation occurs. When boundary layer separation occurs when the gas flow rate is 10 m/s, the pressure of the gas is 20 PSI, and the cutting speed of the piece of sheet metal is 25 m/min, these operational parameters may be correlated with the at least one region where the curvatures and angles exist.

Then, at 212, the sheet metal cutting program 150 identifies the at least one operational parameter that resulted in the problem condition. The at least one operational parameter is identified based on the correlation. For example, when boundary layer separation occurs when the gas flow rate is 10 m/s, the pressure of the gas is 20 PSI, and the cutting speed of the piece of sheet metal is 25 m/min, the at least one operational parameter that resulted in the problem condition may be the 10 m/s gas flow rate, the 20 PSI gas pressure, and the 25 m/min cutting speed.

According to at least one embodiment, when multiple operational parameters are present at the at least one region where the problem condition occurred, the multiple operational parameters may weigh differently in causing the problem condition. For example, the 10 m/s gas flow rate may have more of a direct influence on the boundary layer separation than the 25 m/min cutting speed. In this embodiment, identifying the at least one operational parameter that resulted in the problem condition may include inputting a plurality of historical schlieren images containing a variety of operational parameters and a variety of cut profiles into a convolutional neural network (CNN). The CNN may then output the at least one operational parameter based on the plurality of historical schlieren images.

For example, the associated historical operational parameters of a first historical schlieren image may be the 10 m/s gas flow rate, the 20 PSI gas pressure, and the 25 m/min cutting speed and the first historical schlieren image may indicate that the boundary layer separation occurred. Continuing the example, the associated historical operational parameters of a second historical schlieren image may be the 10 m/s gas flow rate, a 10 PSI gas pressure, and a 30 m/min cutting speed and the second historical schlieren image may indicate that the boundary layer separation did not occur. In this example, since the 10 m/s gas flow rate is the common operational parameter, the CNN may identify and output the 10 m/s gas flow rate as the at least one operational parameter that resulted in the problem condition.

According to at least one other embodiment, the sheet metal cutting program 150 may perform post-production quality evaluation of the product produced by the current laser-based sheet metal cutting operation. For example, where the product produced is the cookie sheet, the sheet metal cutting program 150 may identify one or more defects in the cookie sheet, such as jagged edges or non-symmetric curvatures and angles in the cut profile. Accordingly, the sheet metal cutting program 150 may identify the one or more operational parameters that resulted in the defective work product as the at least one operational parameter that resulted in the problem condition.

Next, at 214, the sheet metal cutting program 150 adapts the at least one operational parameter such that the problem condition is eliminated. The at least one operational parameter is adapted based on the historical data. Examples of the adapted operational parameter may include, but are not limited to, the flow rate of the gas, the pressure of the gas, the angle of the nozzle applying the gas, the cutting speed of the sheet metal, and/or the backpressure of the gas.

According to at least one embodiment, where the problem condition is detected in the one or more regions in real-time, the at least one operational parameter may be adapted as soon as the problem condition is detected. The at least one operational parameter may be adapted to a value that the historical data indicates would not result in the problem condition. For example, where the current operational parameters are the 20 m/s gas flow rate, the 20 PSI gas pressure, and the 25 m/min cutting speed, and the historical data indicates that the problem condition does not occur under a 10 m/s gas flow rate, a 10 PSI gas pressure, and a 20 m/min cutting speed, the current operational parameters may be changed to the 10 m/s gas flow rate, a 10 PSI gas pressure, and a 20 m/min cutting speed.

According to at least one other embodiment, where the problem condition is predicted in the one or more regions based on the historical data (e.g., the associated historical operating parameters in the historical schlieren dataset), the at least one operational parameter may be adapted proactively. For example, where the current operational parameters are the 20 m/s gas flow rate, the 20 PSI gas pressure, and the 25 m/min cutting speed, and the associated historical operating parameters in the historical schlieren dataset indicates that the problem condition does not occur under a 10 m/s gas flow rate, a 10 PSI gas pressure, and a 20 m/min cutting speed, the current operational parameters may be changed to the 10 m/s gas flow rate, a 10 PSI gas pressure, and a 20 m/min cutting speed.

In either embodiment described above, adapting the at least one operational parameter may include causing a backpressure suction module to execute a suction of a gas together with one or more particles of the piece of sheet metal. The backpressure suction module may be positioned beneath the platform on which the piece of sheet metal rests, and may perform suction of the gas and the one or more particles as the piece of sheet metal is being cut. The backpressure suction module may include components such as, but not limited to, dampers and valves. Causing the backpressure suction module to execute the suction of the gas together with the one or more particles of the piece of sheet metal may include adjusting a valve and a damper of the backpressure suction module to a pre-determined position. The pre-determined position may be a setting that increases or decreases suction to a rate where the problem condition is eliminated. Thus, it may be appreciated that in embodiments of the present invention, the gas pressure and the gas flow rate may be regulated by the nozzle itself and/or the backpressure suction module. For example, by increasing suction the backpressure suction module may increase the flow rate of the gas and eliminate the boundary layer separation and any reverse flow of the gas.

Referring now to FIG. 3, an exemplary diagram 300 depicting a laser-based cutting of a sheet metal is shown according to at least one embodiment. In the diagram 300, the piece of sheet metal 302 is being cut in a laser-based sheet metal cutting operation. A nozzle 304 may include the lenses 306 of the schlieren imaging system. The lenses 306 of the schlieren imaging system may capture the one or more operational parameters as well as the problem condition, such as the boundary layer separation. The nozzle 304 may be applying the gas 308 and the laser beam 310 to the piece of sheet metal 302. The gas 308 may be comprised of oxygen or nitrogen. The laser beam 310 may be cutting through a portion of the piece of sheet metal 302 in a direction of a first arrow 312. The laser beam 310 may be cutting through the portion of the piece of sheet metal 302 at an angle φ with respect to an x-axis. By cutting through the portion of the piece of sheet metal 302 in the direction of the first arrow 312, the laser beam 310 may be creating a molten front 314. Based on detecting a boundary layer separation at one or more regions of the piece of sheet metal 302, the backpressure suction module 316 may be performing suction of the gas 308 and the molten front 314 in a direction of a second arrow 318. Additionally, to prevent the boundary layer separation, the an angle φ at which the laser beam 310 is cutting through the portion of the piece of sheet metal 302 may be the at least one operational parameter that is adapted.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of dynamic control of operational parameters in laser-based sheet metal cutting, the method comprising:
receiving real-time and historical data from one or more sources in a sheet metal cutting environment;
computing one or more operational parameters during a cutting of a piece of sheet metal based on the real-time data;
identifying a cut profile and one or more specifications of the piece of sheet metal based on the real-time data;
determining whether a problem condition occurs in one or more regions of the piece of sheet metal based on the cut profile and the one or more specifications;
based on determining the problem condition occurs in at least one region of the one or more regions, correlating the one or more operational parameters with the at least one region where the problem condition occurred;
identifying at least one operational parameter that resulted in the problem condition based on the correlation; and
adapting the at least one operational parameter such that the problem condition is eliminated based on the historical data.

2. The computer-based method of claim 1, wherein adapting the at least one operational parameter further comprises:
causing a backpressure suction module to execute a suction of a gas together with one or more particles of the piece of sheet metal.

3. The computer-based method of claim 2, wherein causing the backpressure suction module to execute the suction of the gas together with the one or more particles of the piece of sheet metal further comprises:
adjusting a valve and a damper of the backpressure suction module to a pre-determined position.

4. The computer-based method of claim 1, wherein the problem condition is a boundary layer separation at the one or more regions of the piece of sheet metal.

5. The computer-based method of claim 4, wherein determining that the problem condition occurs in the one or more regions further comprises:
detecting the boundary layer separation in the one or more regions in real-time based on one or more captured schlieren images during the cutting of the piece of sheet metal.

6. The computer-based method of claim 4, wherein:
determining that the problem condition occurs in the one or more regions includes predicting the boundary layer separation in the one or more regions based on the historical data; and
identifying the at least one operational parameter that resulted in the problem condition further comprises:
inputting a plurality of historical schlieren images containing a variety of operational parameters and a variety of cut profiles and specifications into a convolutional neural network (CNN); and
outputting, by the CNN, the at least one operational parameter based on the plurality of historical schlieren images.

7. The computer-based method of claim 1, wherein the adapted operational parameter is selected from a group consisting of a flow rate of a gas, a pressure of the gas, and an angle of a nozzle applying the gas.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving real-time and historical data from one or more sources in a sheet metal cutting environment;
computing one or more operational parameters during a cutting of a piece of sheet metal based on the real-time data;
identifying a cut profile and one or more specifications of the piece of sheet metal based on the real-time data;
determining whether a problem condition occurs in one or more regions of the piece of sheet metal based on the cut profile and the one or more specifications;
based on determining the problem condition occurs in at least one region of the one or more regions, correlating the one or more operational parameters with the at least one region where the problem condition occurred;
identifying at least one operational parameter that resulted in the problem condition based on the correlation; and
adapting the at least one operational parameter such that the problem condition is eliminated based on the historical data.

9. The computer system of claim 8, wherein adapting the at least one operational parameter further comprises:
causing a backpressure suction module to execute a suction of a gas together with one or more particles of the piece of sheet metal.

10. The computer system of claim 9, wherein causing the backpressure suction module to execute the suction of the gas together with the one or more particles of the piece of sheet metal further comprises:
adjusting a valve and a damper of the backpressure suction module to a pre-determined position.

11. The computer system of claim 8, wherein the problem condition is a boundary layer separation at the one or more regions of the piece of sheet metal.

12. The computer system of claim 11, wherein determining that the problem condition occurs in the one or more regions further comprises:
detecting the boundary layer separation in the one or more regions in real-time based on one or more captured schlieren images during the cutting of the piece of sheet metal.

13. The computer system of claim 11, wherein:
determining that the problem condition occurs in the one or more regions includes predicting the boundary layer separation in the one or more regions based on the historical data; and
identifying the at least one operational parameter that resulted in the problem condition further comprises:
inputting a plurality of historical schlieren images containing a variety of operational parameters and a variety of cut profiles and specifications into a convolutional neural network (CNN); and
outputting, by the CNN, the at least one operational parameter based on the plurality of historical schlieren images.

14. The computer system of claim 8, wherein the adapted operational parameter is selected from a group consisting of a flow rate of a gas, a pressure of the gas, and an angle of a nozzle applying the gas.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving real-time and historical data from one or more sources in a sheet metal cutting environment;
computing one or more operational parameters during a cutting of a piece of sheet metal based on the real-time data;
identifying a cut profile and one or more specifications of the piece of sheet metal based on the real-time data;
determining whether a problem condition occurs in one or more regions of the piece of sheet metal based on the cut profile and the one or more specifications;
based on determining the problem condition occurs in at least one region of the one or more regions, correlating the one or more operational parameters with the at least one region where the problem condition occurred;
identifying at least one operational parameter that resulted in the problem condition based on the correlation; and
adapting the at least one operational parameter such that the problem condition is eliminated based on the historical data.

16. The computer program product of claim 15, wherein adapting the at least one operational parameter further comprises:
causing a backpressure suction module to execute a suction of a gas together with one or more particles of the piece of sheet metal.

17. The computer program product of claim 16, wherein causing the backpressure suction module to execute the suction of the gas together with the one or more particles of the piece of sheet metal further comprises:
adjusting a valve and a damper of the backpressure suction module to a pre-determined position.

18. The computer program product of claim 15, wherein the problem condition is a boundary layer separation at the one or more regions of the piece of sheet metal.

19. The computer program product of claim 18, wherein determining that the problem condition occurs in the one or more regions further comprises:
detecting the boundary layer separation in the one or more regions in real-time based on one or more captured schlieren images during the cutting of the piece of sheet metal.

20. The computer program product of claim 18, wherein:
determining that the problem condition occurs in the one or more regions includes predicting the boundary layer separation in the one or more regions based on the historical data; and
identifying the at least one operational parameter that resulted in the problem condition further comprises:
inputting a plurality of historical schlieren images containing a variety of operational parameters and a variety of cut profiles and specifications into a convolutional neural network (CNN); and
outputting, by the CNN, the at least one operational parameter based on the plurality of historical schlieren images.
